(19) United States
(12) Patent Application Publication
(10) Pub. No.: US 2021/0357667 A1
(43) Pub. Date: Nov. 18, 2021

(54) Methods and Systems for Measuring and Mapping Traffic Signals

(71) Applicant: Great Wall Motor Company Limited, Baoding (CN)

(72) Inventors: Mengping Zhu, Ann Arbor, MI (US); Jingfu Jin, Novi, MI (US); Vladimir Djapic, West Bloomfield, MI (US)

(73) Assignee: Great Wall Motor Company Limited, Baoding (CN)

(21) Appl. No.: 16/872,564

(22) Filed: May 12, 2020

(51) Int. Cl. G06K 9/00; G06T 7/80; G06T 7/70; G05D 1/02; G06K 9/62

(52) U.S. Cl. CPC G06K 9/00825; G06T 7/80; G06T 7/70; G01S 19/47; G06K 9/6267; G06T 2207/30252; G05D 2201/0213; G05D 1/0246

(57) ABSTRACT

Disclosed herein are methods and systems for measuring and mapping traffic signals in global coordinates. A method includes obtaining an image of an environment for a vehicle location, detecting a traffic signal in the image, classifying the detected traffic signal, obtaining traffic signal specification information associated with the classified traffic signal, determining a control point associated with the classified traffic signal, determining a 3D position of the control point in camera space using the traffic signal specification information, camera calibration information, image pixel size, and focal length of camera used in capturing the image, transforming the 3D position of the control point in the camera space to a 3D position of the control point in global coordinates, saving the 3D position of the control point in global coordinates in a map, and controlling operation of a vehicle with 3D positions of control points in global coordinates saved in the map.

### TECHNICAL FIELD

This disclosure relates to assisted driving and autonomous vehicles. More specifically, this disclosure relates to methods for measuring and mapping traffic signals in global or world coordinates.

### BACKGROUND

Autonomous vehicles and assisted driving systems may use a variety of sensors such as, but not limited to, High/Middle Definition (HD/MD) Maps, 3D light detection and ranging (LiDAR), cameras, global positioning system (GPS), inertial measurement unit (IMU), radar, and the like, for a variety of functions such as, but not limited to, landmark detection, collision avoidance, parking, navigation, and guidance.

The HD/MD Maps are extremely high precision at the centimeter-level because the autonomous vehicles and assisted driving systems need very precise instructions to navigate. The HD/MD Maps include, but are not limited to, traffic signals, traffic lights, traffic signs, stop signs, and the like (collectively “traffic signals”). The HD/MD Maps help the autonomous vehicles and assisted driving systems to detect traffic signals and navigate the vehicle safely

Due to the ever increasing interest in autonomous vehicles and assisted driving systems, more and more attention has been devoted to mapping road information including traffic signals. Traditionally, the traffic signals are manually extracted and measured from globally registered 3D data collected from lidar and global positioning system (GPS) sensors. Lidar sensors typically have very limited vertical field of view and limited vertical resolution. Traffic signals such as highway signs are high above the ground and require a wide vertical field of view. Small traffic signals such as traffic lights require a high vertical resolution. Consequently, using lidar sensors to measure traffic signals is difficult and can be expensive.

### SUMMARY

Disclosed herein are methods and systems for measuring and mapping traffic signals in global or world coordinates.

In implementations, a method for measuring a traffic signal in global coordinates, the method including obtaining an image of an environment for a vehicle location, detecting a traffic signal in the image, classifying the detected traffic signal, obtaining traffic signal specification information associated with the classified traffic signal, determining a control point associated with the classified traffic signal, determining a 3D position of the control point in camera space using the traffic signal specification information, camera calibration information, image pixel size, and focal length of camera used in capturing the image, transforming the 3D position of the control point in the camera space to a 3D position of the control point in global coordinates, saving the 3D position of the control point in global coordinates in a digital map, and controlling operation of a vehicle with 3D positions of control points in global coordinates saved in the digital map.

In implementations, a system including a digital map configured to store 3D positions of control points of traffic signals in global coordinates, a processor in communication with the digital map, the processor configured to obtain an image of environment for a vehicle location, detect a traffic signal in the image, classify the detected traffic signal, obtain traffic signal specification information associated with the classified traffic signal, determine a control point associated with the classified traffic signal, determine a 3D position of the control point in camera space using the traffic signal specification information, camera calibration information, image pixel size, and focal length of camera used in capturing the image, transform the 3D position of the control point in the camera space to a 3D position of the control point in global coordinates, save the 3D position of the control point in global coordinates in the digital map, and a controller connected to the digital library, the controller configured to control operation of a vehicle with 3D positions of control points of traffic signals in global coordinates saved in the digital library.

In implementations, a method for measuring a traffic signal in global coordinates, the method including receiving an image of a scene corresponding to a location of a vehicle, performing object detection to detect a traffic signal in the image, performing classification of the traffic signal detected in the image, obtaining traffic signal specifications associated with the classified traffic signal, performing object detection on the classified traffic signal to obtain a control point, determining a 3D position in camera space of the control point using the traffic signal specifications, image pixel size, and focal length of camera used in capturing the image, transforming the 3D position of the control point in camera space to a 3D position of the control point in global coordinates, storing the 3D position of the control point in global coordinates in a digital map, and operating the vehicle with 3D positions of control points in global coordinates saved in the digital map.

### BRIEF DESCRIPTION OF THE DRAWINGS

The disclosure is best understood from the following detailed description when read in conjunction with the accompanying drawings. It is emphasized that, according to common practice, the various features of the drawings are not to scale. On the contrary, the dimensions of the various features are arbitrarily expanded or reduced for clarity.

FIG. 1 is a diagram of an example of a vehicle in accordance with embodiments of this disclosure.

FIG. 2 is a diagram of an example of the control system shown in FIG. 1.

FIG. 3 is a diagram of an example of a vehicle control system in accordance with embodiments of this disclosure.

FIG. 4 is a diagram of an example of a side view of a vehicle including a vehicle control system in accordance with embodiments of this disclosure.

FIG. 5 is a diagram of an example of a vehicle control system in accordance with embodiments of this disclosure.

FIG. 6 is a diagram of an example of traffic signal specifications in accordance with embodiments of this disclosure.

FIG. 7 is a diagram of an example of a vehicle in accordance with embodiments of this disclosure.

FIG. 8 is a diagram of an example of a general framework for measuring and mapping traffic signals in global or world coordinates in accordance with embodiments of this disclosure.

FIG. 9 is a flowchart of an example method for measuring and mapping traffic signals in global or world coordinates in accordance with embodiments of this disclosure.

FIG. 10 is a flowchart of an example method for measuring and mapping traffic signals in global or world coordinates in accordance with embodiments of this disclosure.

FIG. 11 is a photograph of an example traffic light measurement using the measuring and mapping traffic signals in global or world coordinates methods in accordance with embodiments of this disclosure.

FIG. 12 is a photograph of an example traffic light measurement using the measuring and mapping traffic signals in global or world coordinates methods in accordance with embodiments of this disclosure.

FIG. 13 is a photograph of an example traffic light measurement using the measuring and mapping traffic signals in global or world coordinates methods in accordance with embodiments of this disclosure.

### DETAILED DESCRIPTION

Reference will now be made in greater detail to a preferred embodiment of the invention, an example of which is illustrated in the accompanying drawings. Wherever possible, the same reference numerals will be used throughout the drawings and the description to refer to the same or like parts.

As used herein, the terminology “computer” or “computing device” includes any unit, or combination of units, capable of performing any method, or any portion or portions thereof, disclosed herein.

As used herein, the terminology “processor” indicates one or more processors, such as one or more special purpose processors, one or more digital signal processors, one or more microprocessors, one or more controllers, one or more microcontrollers, one or more application processors, one or more central processing units (CPU)s, one or more graphics processing units (GPU)s, one or more digital signal processors (DSP)s, one or more application specific integrated circuits (ASIC)s, one or more application specific standard products, one or more field programmable gate arrays, any other type or combination of integrated circuits, one or more state machines, or any combination thereof.

As used herein, the terminology “memory” indicates any computer-usable or computer-readable medium or device that can tangibly contain, store, communicate, or transport any signal or information that may be used by or in connection with any processor. For example, a memory may be one or more read-only memories (ROM), one or more random access memories (RAM), one or more registers, low power double data rate (LPDDR) memories, one or more cache memories, one or more semiconductor memory devices, one or more magnetic media, one or more optical media, one or more magneto-optical media, or any combination thereof.

As used herein, the terminology “instructions” may include directions or expressions for performing any method, or any portion or portions thereof, disclosed herein, and may be realized in hardware, software, or any combination thereof. For example, instructions may be implemented as information, such as a computer program, stored in memory that may be executed by a processor to perform any of the respective methods, algorithms, aspects, or combinations thereof, as described herein. Instructions, or a portion thereof, may be implemented as a special purpose processor, or circuitry, that may include specialized hardware for carrying out any of the methods, algorithms, aspects, or combinations thereof, as described herein. In some implementations, portions of the instructions may be distributed across multiple processors on a single device, on multiple devices, which may communicate directly or across a network such as a local area network, a wide area network, the Internet, or a combination thereof.

As used herein, the terminology “determine” and “identify,” or any variations thereof includes selecting, ascertaining, computing, looking up, receiving, determining, establishing, obtaining, or otherwise identifying or determining in any manner whatsoever using one or more of the devices and methods are shown and described herein.

As used herein, the terminology “example,” “the embodiment,” “implementation,” “aspect,” “feature,” or “element” indicates serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “or” is intended to mean an inclusive “or” rather than an exclusive “or.” That is unless specified otherwise, or clear from context, “X includes A or B” is intended to indicate any of the natural inclusive permutations. That is if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from the context to be directed to a singular form.

Further, for simplicity of explanation, although the figures and descriptions herein may include sequences or series of steps or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure. Although aspects, features, and elements are described herein in particular combinations, each aspect, feature, or element may be used independently or in various combinations with or without other aspects, features, and elements.

Described herein is a method to measure and map traffic signals in global or world coordinates. In implementations, the methods can apply object detection and classification techniques to images captured by on-board vehicle cameras to detect and classify a traffic signal present in the image. Traffic signal specification information is matched against the classified traffic signal to obtain, for example, size parameters for the classified traffic signal. The size parameters along with the camera information are used to determine a 3D position of the classified traffic signal in camera space. The 3D position of the classified traffic signal in camera space is then time synchronized and transformed to global or world (collectively “global”) coordinates. The 3D position of the classified traffic signal in global coordinates is saved in a HD/MD Map. The stored traffic signal positions can be queried by a vehicle controller to control and navigate the vehicle.

In implementations, traffic signal specification information is available from publicly available sources. The traffic signal specification information is digitized and stored in a database, such as, for example, along with the HD/MD Map.

In implementations, in the event of visibility issues or occlusion due to inclement weather, structures, trees, and the like, the methods can use alternate sources of imagery based on the vehicle location. The alternate imagery can be aligned with the current location to determine locations of the traffic signals. As before, the traffic signals are detected, classified, and matched traffic signal specification information is obtained. The alternate imagery is provided with the information needed to determine a 3D position of the classified traffic signal in camera space. As before, the 3D position of the classified traffic signal in global coordinates is saved in the HD/MD Map and can be queried by a vehicle controller to control and navigate the vehicle.

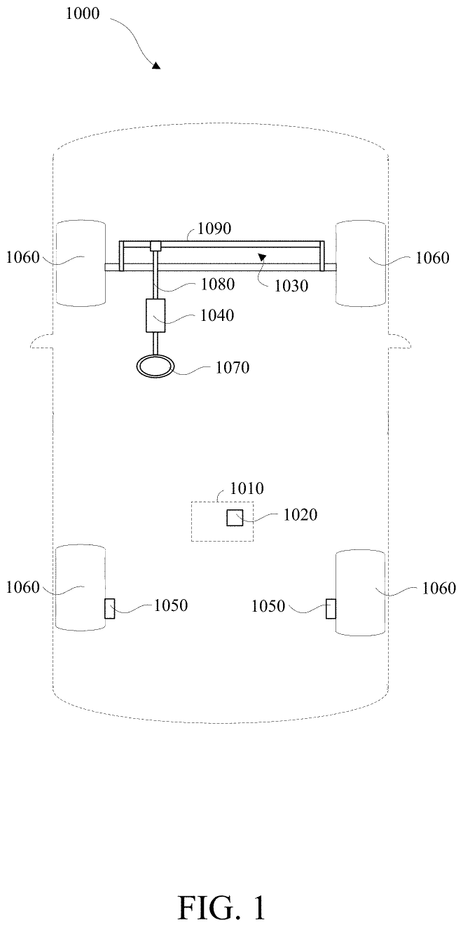

FIG. 1 is a diagram of an example of a vehicle 1000 in accordance with embodiments of this disclosure. The vehicle 1000 may be an autonomous vehicle (AV) or a semi-autonomous vehicle. As shown in FIG. 1, the vehicle 1000 includes a control system 1010. The control system 1010 may be referred to as a controller. The control system 1010 includes a processor 1020. The processor 1020 is programmed to command application of one of up to a predetermined steering torque value and up to a predetermined net asymmetric braking force value. Each predetermined force is selected to achieve a predetermined vehicle yaw torque that is at most the lesser of a first maximum yaw torque resulting from actuating a steering system 1030 and a second maximum yaw torque resulting from actuating a brake system.

The steering system 1030 may include a steering actuator 1040 that is an electric power-assisted steering actuator. The brake system may include one or more brakes 1050 coupled to respective wheels 1060 of the vehicle 1000. Additionally, the processor 1020 may be programmed to command the brake system to apply a net asymmetric braking force by each brake 1050 applying a different braking force than the other brakes 1050.

The processor 1020 may be further programmed to command the brake system to apply a braking force, for example, a net asymmetric braking force, in response to a failure of the steering system 1030. Additionally or alternatively, the processor 1020 may be programmed to provide a warning to an occupant in response to the failure of the steering system 1030. The steering system 1030 may be a power-steering control module. The control system 1010 may include the steering system 1030. Additionally, the control system 1010 may include the brake system.

The steering system 1030 may include a steering actuator 1040 that is an electric power-assisted steering actuator. The brake system may include two brakes 1050 coupled to respective wheels 1060 on opposite sides of the vehicle 1000. Additionally, the method may include commanding the brake system to apply a net asymmetric braking force by each brake 1050 applying a different braking force.

The control system 1010 allows one of the steering system 1030 and the brake system to take over for the other of the steering system 1030 and the brake system if the other fails while the vehicle 1000 is executing a turn. Whichever of the steering system 1030 and the braking system remains operable is then able to apply sufficient yaw torque to the vehicle 1000 to continue the turn. The vehicle 1000 is, therefore, less likely to impact an object such as another vehicle or a roadway barrier, and any occupants of the vehicle 1000 are less likely to be injured.

The vehicle 1000 may operate in one or more of the levels of autonomous vehicle operation. For purposes of this disclosure, an autonomous mode is defined as one in which each of propulsion (e.g., via a powertrain including an electric motor and/or an internal combustion engine), braking, and steering of the vehicle 1000 are controlled by the processor 1020; in a semi-autonomous mode the processor 1020 controls one or two of the propulsion, braking, and steering of the vehicle 1000. Thus, in one example, non-autonomous modes of operation may refer to SAE levels 0-1, partially autonomous or semi-autonomous modes of operation may refer to SAE levels 2-3, and fully autonomous modes of operation may refer to SAE levels 4-5.

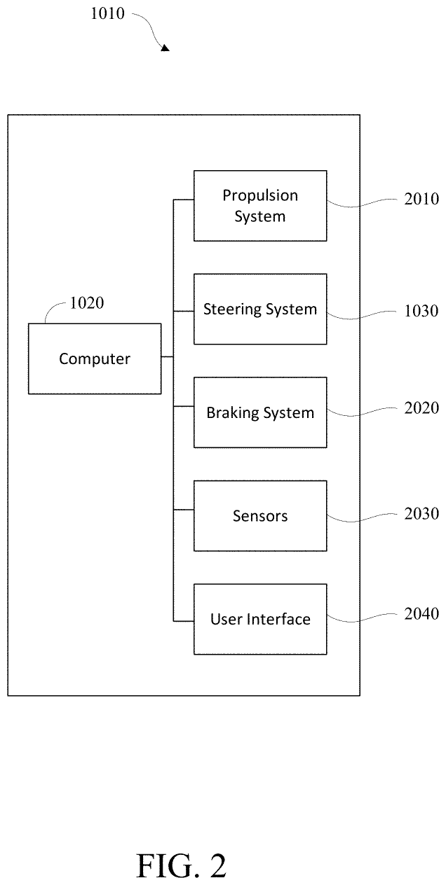

With reference to FIG. 2, the control system 1010 includes the processor 1020. The processor 1020 is included in the vehicle 1000 for carrying out various operations, including as described herein. The processor 1020 is a computing device that generally includes a processor and a memory, the memory including one or more forms of computer-readable media, and storing instructions executable by the processor for performing various operations, including as disclosed herein. The memory of the processor 1020 further generally stores remote data received via various communications mechanisms; e.g., the processor 1020 is generally configured for communications on a communications network within the vehicle 1000. The processor 1020 may also have a connection to an onboard diagnostics connector (OBD-II). Although one processor 1020 is shown in FIG. 2 for ease of illustration, it is to be understood that the processor 1020 could include, and various operations described herein could be carried out by one or more computing devices. The processor 1020 may be a control module, for example, a power-steering control module, or may include a control module among other computing devices.

The control system 1010 may transmit signals through the communications network, which may be a controller area network (CAN) bus, Ethernet, Local Interconnect Network (LIN), Bluetooth, and/or by any other wired or wireless communications network. The processor 1020 may be in communication with a propulsion system 2010, the steering system 1030, the brake system 2020, sensors 2030, and/or a user interface 2040, among other components.

With continued reference to FIG. 2, the propulsion system 2010 of the vehicle 1000 generates energy and translates the energy into motion of the vehicle 1000. The propulsion system 2010 may be a known vehicle propulsion subsystem, for example, a conventional powertrain including an internal-combustion engine coupled to a transmission that transfers rotational motion to road wheels 1060; an electric powertrain including batteries, an electric motor, and a transmission that transfers rotational motion to the road wheels 1060; a hybrid powertrain including elements of the conventional powertrain and the electric powertrain; or any other type of propulsion. The propulsion system 2010 is in communication with and receives input from the processor 1020 and from a human driver. The human driver may control the propulsion system 2010 via, e.g., an accelerator pedal and/or a gear-shift lever (not shown).

With reference to FIGS. 1 and 2, the steering system 1030 is typically a known vehicle steering subsystem and controls the turning of the road wheels 1060. The steering system 1030 is in communication with and receives input from a steering wheel 1070 and the processor 1020. The steering system 1030 may be a rack-and-pinion system with electric power-assisted steering via a steering actuator 1040, a steer-by-wire system, as are both known in the art, or any other suitable system. The steering system 1030 may include the steering wheel 1070 fixed to a steering column 1080 coupled to a steering rack 1090.

With reference to FIG. 1, the steering rack 1090 is turnably coupled to the road wheels 1060, for example, in a four-bar linkage. Translational motion of the steering rack 1090 results in turning off the road wheels 1060. The steering column 1080 may be coupled to the steering rack 1090 via a rack-and-pinion, that is, gear meshing between the pinion gear and rack gear (not shown).

The steering column 1080 transfers rotation of the steering wheel 1070 to movement of the steering rack 1090. The steering column 1080 may be, e.g., a shaft connecting the steering wheel 1070 to the steering rack 1090. The steering column 1080 may house a torsion sensor and a clutch (not shown).

The steering wheel 1070 allows an operator to steer the vehicle 1000 by transmitting rotation of the steering wheel 1070 to movement of the steering rack 1090. The steering wheel 1070 may be, e.g., a rigid ring fixedly attached to the steering column 1080 such as is known.

With continued reference to FIG. 1, the steering actuator 1040 is coupled to the steering system 1030, e.g., the steering column 1080, so as to cause turning of the road wheels 1060. For example, the steering actuator 1040 may be an electric motor rotatably coupled to the steering column 1080, that is, coupled so as to be able to apply a steering torque to the steering column 1080. The steering actuator 1040 may be in communication with the processor 1020.

The steering actuator 1040 may provide power assist to the steering system 1030. In other words, the steering actuator 1040 may provide torque in a direction in which the steering wheel 1070 is being rotated by a human driver, allowing the driver to turn the steering wheel 1070 with less effort. The steering actuator 1040 may be an electric power-assisted steering actuator.

With reference to FIGS. 1 and 2, the brake system 2020 is typically a known vehicle braking subsystem and resists the motion of the vehicle 1000 to thereby slow and/or stop the vehicle 1000. The brake system 2020 includes brakes 1050 coupled to the road wheels 1060. The brakes 1050 may be friction brakes such as disc brakes, drum brakes, band brakes, and so on; regenerative brakes; any other suitable type of brakes; or a combination. The brakes 1050 may be coupled to, e.g., respective road wheels 1060 on opposite sides of the vehicle 1000. The brake system 2020 is in communication with and receives input from the processor 1020 and a human driver. The human driver may control the braking via, e.g., a brake pedal (not shown).

With reference to FIG. 2, the vehicle 1000 may include the sensors 2030. The sensors 2030 may detect internal states of the vehicle 1000, for example, wheel speed, wheel orientation, and engine and transmission variables. The sensors 2030 may detect the position or orientation of the vehicle 1000, for example, global positioning system (GPS) sensors; accelerometers such as piezo-electric or microelectromechanical systems (MEMS); gyroscopes such as rate, a ring laser, or fiber-optic gyroscopes; inertial measurements units (IMU); and magnetometers. The sensors 2030 may detect the external world, for example, radar sensors, scanning laser rangefinders, light detection and ranging (LIDAR) devices, and image processing sensors such as cameras. The sensors 2030 may include communications devices, for example, vehicle-to-infrastructure (V2I) devices, vehicle-to-vehicle (V2V) devices, or vehicle-to-everything (V2E) devices.

The user interface 2040 presents information to and receives information from an occupant of the vehicle 1000. The user interface 2040 may be located, e.g., on an instrument panel in a passenger cabin (not shown) of the vehicle 1000, or wherever may be readily seen by the occupant. The user interface 2040 may include dials, digital readouts, screens, speakers, and so on for output, i.e., providing information to the occupant, e.g., a human-machine interface (HMI) including elements such as are known. The user interface 2040 may include buttons, knobs, keypads, touchscreens, microphones, and so on for receiving input, i.e., information, instructions, etc., from the occupant.

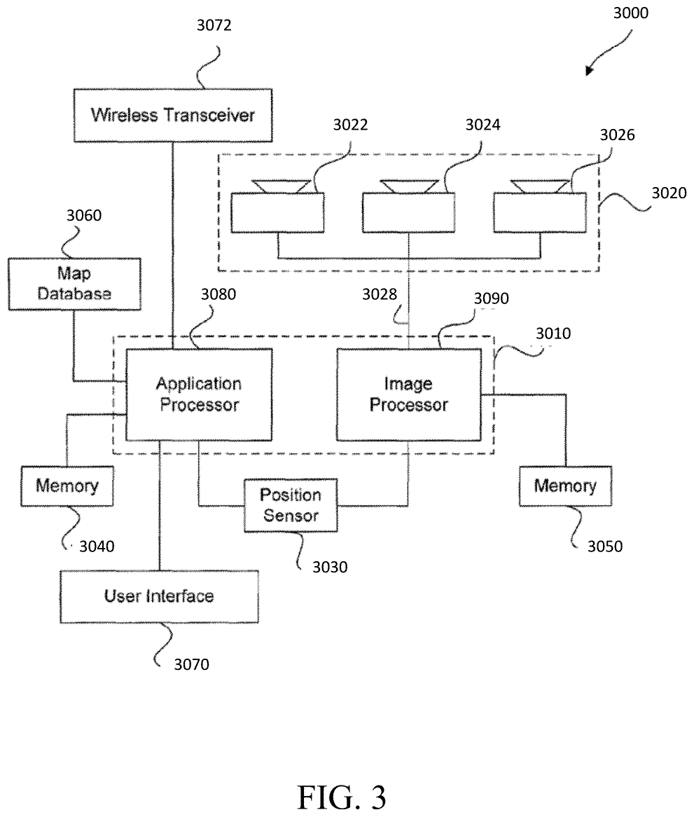

FIG. 3 is a diagram of an example of a vehicle control system 3000 in accordance with embodiments of this disclosure. Vehicle control system 3000 may include various components depending on the requirements of a particular implementation. In some embodiments, vehicle control system 3000 may include a processing unit 3010, an image acquisition unit 3020, a position sensor 3030, one or more memory units 3040, 3050, a map database 3060, a user interface 3070, and a wireless transceiver 3072. Processing unit 3010 may include one or more processing devices. In some embodiments, processing unit 3010 may include an applications processor 3080, an image processor 3090, or any other suitable processing device. Similarly, image acquisition unit 3020 may include any number of image acquisition devices and components depending on the requirements of a particular application. In some embodiments, image acquisition unit 3020 may include one or more image capture devices (e.g., cameras, CCDs, or any other type of image sensor), such as image capture device 3022, an image capture device 3024, an image capture device 3026. System 3000 may also include a data interface 3028 communicatively connecting processing unit 3010 to image acquisition unit 3020. For example, data interface 3028 may include any wired and/or wireless link or links for transmitting image data acquired by image acquisition unit 3020 to processing unit 3010.

Wireless transceiver 3072 may include one or more devices configured to exchange transmissions over an air interface to one or more networks (e.g., cellular, the Internet, etc.) by use of a radio frequency, infrared frequency, magnetic field, or an electric field. Wireless transceiver 3072 may use any known standard to transmit and/or receive data (e.g., Wi-Fi, Bluetooth®, Bluetooth Smart, 802.15.4, ZigBee, etc.). Such transmissions may include communications from the host vehicle to one or more remotely located servers. Such transmissions may also include communications (one-way or two-way) between the host vehicle and one or more target vehicles in an environment of the host vehicle (e.g., to facilitate coordination of navigation of the host vehicle in view of or together with target vehicles in the environment of the host vehicle), or even a broadcast transmission to unspecified recipients in a vicinity of the transmitting vehicle.

Both applications processor 3080 and image processor 3090 may include various types of hardware-based processing devices. For example, either or both of applications processor 3080 and image processor 3090 may include a microprocessor, preprocessors (such as an image preprocessor), graphics processors, a central processing unit (CPU), support circuits, digital signal processors, integrated circuits, memory, or any other types of devices suitable for running applications and for image processing and analysis. In some embodiments, applications processor 180 and/or image processor 190 may include any type of single or multi-core processor, mobile device microcontroller, the central processing unit, or the like.

In some embodiments, applications processor 3080 and/or image processor 3090 may include multiple processing units with local memory and instruction sets. Such processors may include video inputs for receiving image data from multiple image sensors and may also include video out capabilities. In one example, the processor may use 90 nm-micron technology operating at 332 Mhz.

Any of the processing devices disclosed herein may be configured to perform certain functions. Configuring a processing device, such as any of the described processors, other controllers or microprocessors, to perform certain functions may include programming of computer-executable instructions and making those instructions available to the processing device for execution during operation of the processing device. In some embodiments, configuring a processing device may include programming the processing device directly with architectural instructions. In other embodiments, configuring a processing device may include storing executable instructions on a memory that is accessible to the processing device during operation. For example, the processing device may access the memory to obtain and execute the stored instructions during operation. In either case, the processing device configured to perform the sensing, image analysis, and/or navigational functions disclosed herein represents a specialized hardware-based system in control of multiple hardware-based components of a host vehicle.

While FIG. 3 depicts two separate processing devices included in the processing unit 3010, more or fewer processing devices may be used. For example, in some embodiments, a single processing device may be used to accomplish the tasks of applications processor 3080 and image processor 3090. In other embodiments, these tasks may be performed by more than two processing devices. Further, in some embodiments, vehicle control system 3000 may include one or more of processing unit 3010 without including other components, such as image acquisition unit 3020.

Processing unit 3010 may comprise various types of devices. For example, processing unit 3010 may include various devices, such as a controller, an image preprocessor, a central processing unit (CPU), support circuits, digital signal processors, integrated circuits, memory, or any other types of devices for image processing and analysis. The image preprocessor may include a video processor for capturing, digitizing and processing the imagery from the image sensors. The CPU may comprise any number of microcontrollers or microprocessors. The support circuits may be any number of circuits generally well known in the art, including cache, power supply, clock, and input-output circuits. The memory may store software that, when executed by the processor, controls the operation of the system. The memory may include databases and image processing software. The memory may comprise any number of random access memories, read-only memories, flash memories, disk drives, optical storage, tape storage, removable storage and other types of storage. In one instance, the memory may be separate from the processing unit 3010. In another instance, the memory may be integrated into the processing unit 3010.

Each memory 3040, 3050 may include software instructions that when executed by a processor (e.g., applications processor 3080 and/or image processor 3090), may control operation of various aspects of the vehicle control system 3000. These memory units may include various databases and image processing software, as well as a trained system, such as a neural network, or a deep neural network, for example. The memory units may include random access memory, read-only memory, flash memory, disk drives, optical storage, tape storage, removable storage and/or any other types of storage. In some embodiments, memory units 3040, 3050 may be separate from the applications processor 3080 and/or image processor 3090. In other embodiments, these memory units may be integrated into applications processor 3080 and/or image processor 3090.

Position sensor 3030 may include any type of device suitable for determining a location associated with at least one component of the vehicle control system 3000. In some embodiments, position sensor 3030 may include a GPS receiver. Such receivers can determine a user position and velocity by processing signals broadcasted by global positioning system satellites. Position information from position sensor 3030 may be made available to applications processor 3080 and/or image processor 3090.

In some embodiments, vehicle control system 3000 may include components such as a speed sensor (e.g., a speedometer) for measuring a speed of vehicle 1000. Vehicle control system 3000 may also include one or more accelerometers (either single axis or multi-axis) for measuring accelerations of vehicle 1000 along one or more axes.

The memory units 3040, 3050 may include a database, or data organized in any other form, that indication a location of known landmarks. Sensory information (such as images, radar signal, depth information from LIDAR or stereo processing of two or more images) of the environment may be processed together with position information, such as a GPS coordinate, vehicle's ego-motion, etc. to determine a current location of the vehicle relative to the known landmarks, and refine the vehicle location.

User interface 3070 may include any device suitable for providing information to or for receiving inputs from one or more users of the vehicle control system 3000. In some embodiments, user interface 3070 may include user input devices, including, for example, a touchscreen, microphone, keyboard, pointer devices, track wheels, cameras, knobs, buttons, or the like. With such input devices, a user may be able to provide information inputs or commands to vehicle control system 3000 by typing instructions or information, providing voice commands, selecting menu options on a screen using buttons, pointers, or eye-tracking capabilities, or through any other suitable techniques for communicating information to vehicle control system 3000.

User interface 3070 may be equipped with one or more processing devices configured to provide and receive information to or from a user and process that information for use by, for example, applications processor 3080. In some embodiments, such processing devices may execute instructions for recognizing and tracking eye movements, receiving and interpreting voice commands, recognizing and interpreting touches and/or gestures made on a touchscreen, responding to keyboard entries or menu selections, etc. In some embodiments, user interface 3070 may include a display, speaker, tactile device, and/or any other devices for providing output information to a user.

Map database 3060 may include any type of database for storing map data useful to the vehicle control system 3000. In some embodiments, map database 3060 may include data relating to the position, in a reference coordinate system, of various items, including roads, water features, geographic features, businesses, points of interest, restaurants, gas stations, etc. Map database 3060 may store not only the locations of such items but also descriptors relating to those items, including, for example, names associated with any of the stored features. In some embodiments, map database 3060 may be physically located with other components of the vehicle control system 3000. Alternatively or additionally, map database 3060 or a portion thereof may be located remotely with respect to other components of the vehicle control system 3000 (e.g., processing unit 3010). In such embodiments, information from map database 3060 may be downloaded over a wired or wireless data connection to a network (e.g., over a cellular network and/or the Internet, etc.). In some cases, map database 3060 may store a sparse data model including polynomial representations of certain road features (e.g., lane markings) or target trajectories for the host vehicle. Map database 3060 may also include stored representations of various recognized landmarks that may be used to determine or update a known position of the host vehicle with respect to a target trajectory. The landmark representations may include data fields such as landmark type, landmark location, among other potential identifiers.

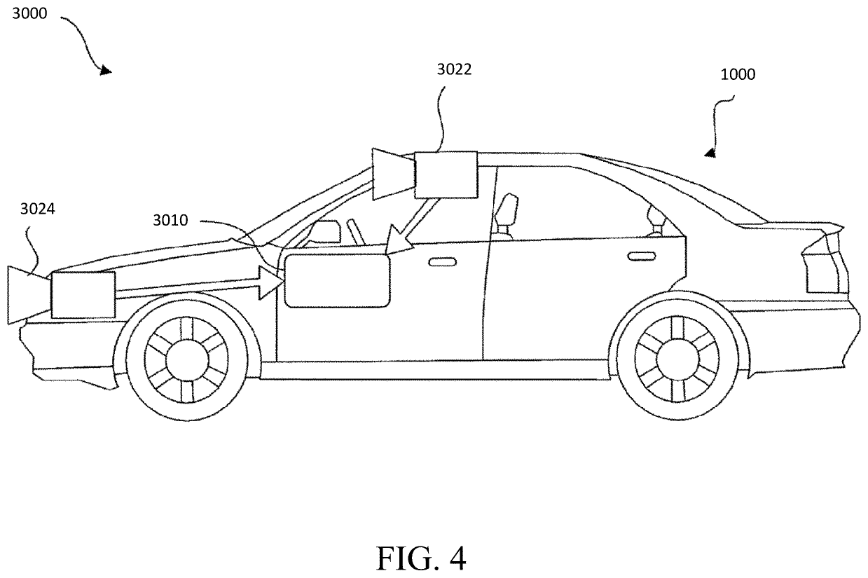

Image capture devices 3022, 3024, and 3026 may each include any type of device suitable for capturing at least one image from an environment. Moreover, any number of image capture devices may be used to acquire images for input to the image processor. Some embodiments may include only a single image capture device, while other embodiments may include two, three, or even four or more image capture devices. Image capture devices 3022, 3024, and 3026 will be further described with reference to FIG. 4 below.

One or more cameras (e.g., image capture devices 3022, 3024, and 3026) may be part of a sensing block included on a vehicle. Various other sensors may be included in the sensing block, and any or all of the sensors may be relied upon to develop a sensed navigational state of the vehicle. In addition to cameras (forward, sideward, rearward, etc), other sensors such as RADAR, LIDAR, and acoustic sensors may be included in the sensing block. Additionally, the sensing block may include one or more components configured to communicate and transmit/receive information relating to the environment of the vehicle. For example, such components may include wireless transceivers (RF, etc.) that may receive from a source remotely located with respect to the host vehicle sensor-based information or any other type of information relating to the environment of the host vehicle. Such information may include sensor output information or related information received from vehicle systems other than the host vehicle. In some embodiments, such information may include information received from a remote computing device, a centralized server, etc. Furthermore, the cameras may take on many different configurations: single camera units, multiple cameras, camera clusters, long FOV, short FOV, wide angle, fisheye, or the like.

FIG. 4 is a diagram of an example of a side view of vehicle 1000 including a vehicle control system 3000 in accordance with embodiments of this disclosure. For example, vehicle 1000 may be equipped with a processing unit 3010 and any of the other components of the vehicle control system 3000, as described above relative to FIG. 3. While in some embodiments vehicle 1000 may be equipped with only a single image capture device (e.g., camera), in other embodiments, multiple image capture devices may be used. For example, either of image capture devices 3022 and 3024 of vehicle 1000, as shown in FIG. 4, may be part of an automated driving system imaging set.

The image capture devices included on vehicle 1000 as part of the image acquisition unit 3020 may be positioned at any suitable location. In some embodiments, image capture device 3022 may be located in the vicinity of the rearview mirror. This position may provide a line of sight similar to that of the driver of vehicle 1000, which may aid in determining what is and is not visible to the driver. Image capture device 3022 may be positioned at any location near the rearview mirror, but placing image capture device 3022 on the driver side of the mirror may further aid in obtaining images representative of the driver's field of view and/or line of sight.

Other locations for the image capture devices of image acquisition unit 3020 may also be used. For example, image capture device 3024 may be located on or in a bumper of vehicle 1000. Such a location may be especially suitable for image capture devices having a wide field of view. The line of sight of bumper-located image capture devices can be different from that of the driver and, therefore, the bumper image capture device and driver may not always see the same objects. The image capture devices (e.g., image capture devices 3022, 3024, and 3026) may also be located in other locations. For example, the image capture devices may be located on or in one or both of the side mirrors of vehicle 1000, on the roof of vehicle 1000, on the hood of vehicle 1000, on the trunk of vehicle 1000, on the sides of vehicle 1000, mounted on, positioned behind, or positioned in front of any of the windows of vehicle 1000, and mounted in or near light fixtures on the front and/or back of vehicle 1000.

In addition to image capture devices, vehicle 1000 may include various other components of the vehicle control system 3000. For example, processing unit 3010 may be included on vehicle 1000 either integrated with or separate from an engine control unit (ECU) of the vehicle. Vehicle 1000 may also be equipped with a position sensor 3030, such as a GPS receiver and may also include a map database 3060 and memory units 3040 and 3050.

As discussed earlier, wireless transceiver 3072 may and/or receive data over one or more networks (e.g., cellular networks, the Internet, etc.). For example, wireless transceiver 3072 may upload data collected by the vehicle control system 3000 to one or more servers, and download data from the one or more servers. Via wireless transceiver 3072, vehicle control system 3000 may receive, for example, periodic or on-demand updates to data stored in map database 3060, memory 3040, and/or memory 3050. Similarly, wireless transceiver 3072 may upload any data (e.g., images captured by image acquisition unit 3020, data received by position sensor 3030 or other sensors, vehicle control systems, etc.) from vehicle control system 3000 and/or any data processed by processing unit 3010 to the one or more servers.

Vehicle control system 3000 may upload data to a server (e.g., to the cloud) based on a privacy level setting. For example, vehicle control system 3000 may implement privacy level settings to regulate or limit the types of data (including metadata) sent to the server that may uniquely identify a vehicle and or driver/owner of a vehicle. Such settings may be set by a user via, for example, wireless transceiver 3072, be initialized by factory default settings, or by data received by wireless transceiver 3072.

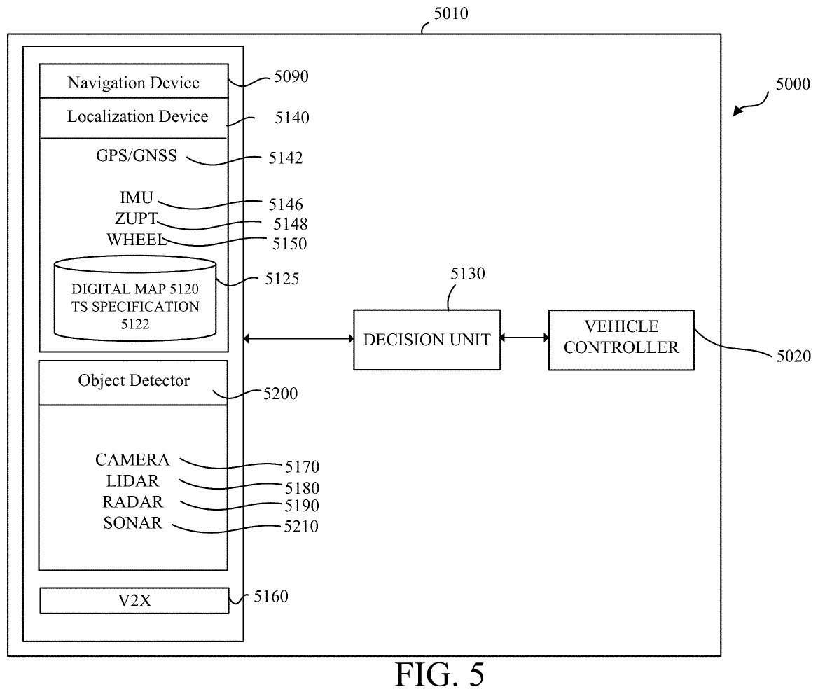

FIG. 5 is a diagram of an example of a vehicle system architecture 5000 in accordance with embodiments of this disclosure. The vehicle system architecture 5000 may be implemented as part of a host vehicle 5010.

The vehicle system architecture 5000 includes a navigation device 5090, a decision unit 5130, object detector 5200, V2X communications 5160, and a vehicle controller 5020. The navigation device 5090 may be used by the decision unit 5130 to determine a travel path of the host vehicle 5010 to a destination. The travel path, for example, may include a travel route or a navigation path. The navigation device 5090, the decision unit 5130, and the vehicle controller 5020 may be collectively used to determine where to steer the host vehicle 5010 along a roadway such that the host vehicle 5010 is appropriately located on the roadway relative to, for example, lane markings, curbs, traffic signs, pedestrians, other vehicles, etc., and determine a route based on a digital map 5120 that the host vehicle 5010 is instructed to follow to arrive at a destination, or both. The digital map 5120 can be stored as a database 5125.

In order to determine where the host vehicle 5010 is located on the digital map 5120, the navigation device 5090 may include a localization device 5140, such as a GPS/GNSS receiver 5142, an inertial measurement unit (IMU) 5146, wheel 5148, and zero velocity update (ZUPT) 5150. A camera 5170, a radar unit 5190, a sonar unit 5210, a LIDAR unit 5180, or any combination thereof may be used to detect relatively permanent objects proximate to the host vehicle 5010 that are indicated on the digital map 5120, for example, traffic signals, buildings, etc., and determine a relative location relative to those objects in order to determine where the host vehicle 5010 is located on the digital map 5120. This process may be referred to as map localization. The functions of the navigation device 5090, the information provided by the navigation device 5090, or both, may be all or in part provided by way of V2I communications, V2V communications, vehicle-to-pedestrian (V2P) communications, or a combination thereof, which may generically be labeled as V2X communications 5160. The navigation device 5090, localization device 5140, or both may include a processor(s) such as a microprocessor or other control circuitry such as analog circuitry, digital circuitry, or both, including an application specific integrated circuit (ASIC) for processing data. The navigation device 5090, localization device 5140, or both may include a memory, including a non-volatile memory, such as electrically erasable programmable read-only memory (EEPROM) for storing one or more routines, thresholds, captured data, or a combination thereof.

In some implementations, the object detector 5200 may include the sonar unit 5210, the camera 5170, the LIDAR unit 5180, and the radar unit 5190. The object detector 5200 may be used to detect the relative location of another entity and determine an intersection point where another entity will intersect the travel path of the host vehicle 5010. In order to determine the intersection point and the relative timing of when the host vehicle 5010 and another entity will arrive at the intersection point, the object detector 5200 may be used by the vehicle system architecture 5000 to determine, for example, a relative speed, a separation distance of another entity from the host vehicle 5010, or both. The functions of the object detector 5200, the information provided by the object detector 5200, or both, may be all or in part provided by way of V2I communications, V2V communications, V2P communications, or a combination thereof, which may generically be labeled as V2X communications 5160. Accordingly, the vehicle system architecture 5000 may include a transceiver to enable such communications. The object detector 5200 may include a processor(s) such as a microprocessor or other control circuitry such as analog circuitry, digital circuitry, or both, including an application specific integrated circuit (ASIC) for processing data. The object detector 5200 may include a memory, including a non-volatile memory, such as electrically erasable programmable read-only memory (EEPROM) for storing one or more routines, thresholds, captured data, or a combination thereof.

The vehicle system architecture 5000 includes a decision unit 5130 that is in communication with the object detector 5200, and the navigation device 5090. The communication may be by way of, but not limited to, wires, wireless communication, or optical fiber. The decision unit 5130 may include a processor(s) such as a microprocessor or other control circuitry such as analog circuitry, digital circuitry, or both, including an application specific integrated circuit (ASIC) for processing data. The decision unit 5130 may include a memory, including a non-volatile memory, such as electrically erasable programmable read-only memory (EEPROM) for storing one or more routines, thresholds, captured data, or a combination thereof. The decision unit 5130 may determine or control route or path planning, local driving behavior, and trajectory planning for the host vehicle 5010.

The vehicle system architecture 5000 includes a vehicle controller or trajectory tracker 5020 that is in communication with the decision unit 5130. The vehicle controller 5020 may execute a defined geometric path by applying appropriate vehicle commands such as steering, throttle, braking and the like motions to physical control mechanisms such as steering, accelerator, brakes, and the like that guide the vehicle along the geometric path. The vehicle controller 5020 may include a processor(s) such as a microprocessor or other control circuitry such as analog circuitry, digital circuitry, or both, including an application specific integrated circuit (ASIC) for processing data. The vehicle controller 5020 may include a memory, including a non-volatile memory, such as electrically erasable programmable read-only memory (EEPROM) for storing one or more routines, thresholds, captured data, or a combination thereof.

The host vehicle 5010 may operate in an automated mode where a human operator is not needed to operate the vehicle 5010. In the automated mode, the vehicle control system 5000 (using, for example, the vehicle controller 5020, the decision unit 5130, navigation device 5090, the object detector 5200 and the other described sensors and devices) autonomously controls the vehicle 5010. Alternatively, the host vehicle may operate in a manual mode where the degree or level of automation may be little more than providing steering advice to a human operator. For example, in manual mode, the vehicle system architecture 5000 may assist the human operator as needed to arrive at a selected destination, avoid interference or collision with another entity, or both, where another entity may be another vehicle, a pedestrian, a building, a tree, an animal, or any other object that the vehicle 5010 may encounter.

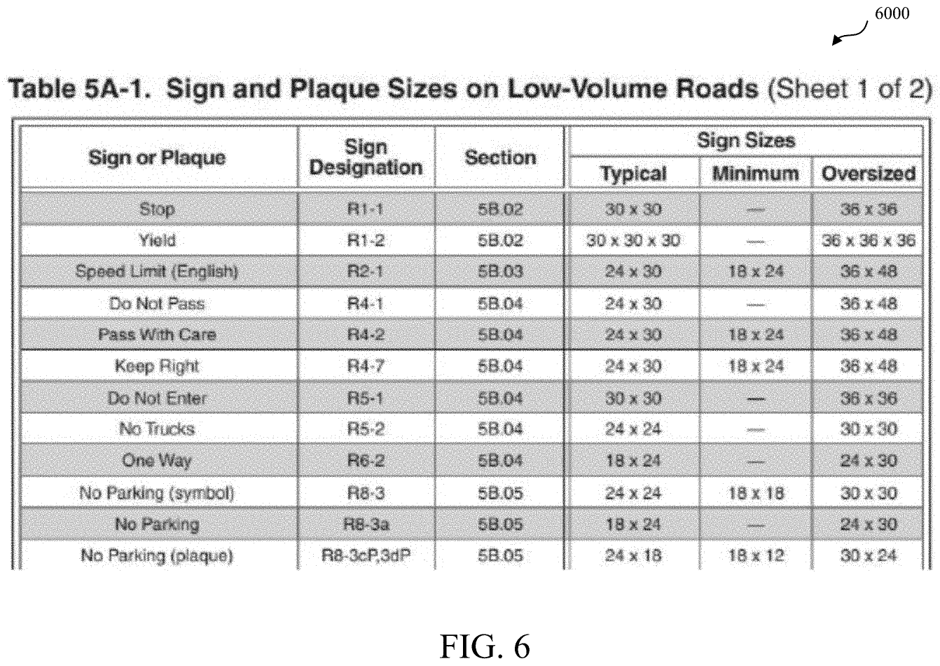

The database 5125 can include traffic signal specifications including, but not limited to, traffic signals, traffic lights, traffic signs, stop signs, and the like (collectively “traffic signals”). Traffic signal specifications are standard manufacturing requirements from governmental Department of Transportation regulations, such as by the U.S. Department of Transportation. See, for example, Manual on Uniform Traffic Control Devices 2009 Edition, Part 4—Highway Traffic Signals (“Manual”), the contents of which are herein incorporated by reference. For example, the Manual dictates two possible diameter sizes of for a traffic light: 8 inch and 12 inch. FIG. 6 shows a partial section of the Manual 6000. The Manual 6000 can be digitized as a portion of the database 5125. In implementations, the traffic signal specifications can be saved as a separate database in the host vehicle 5010.

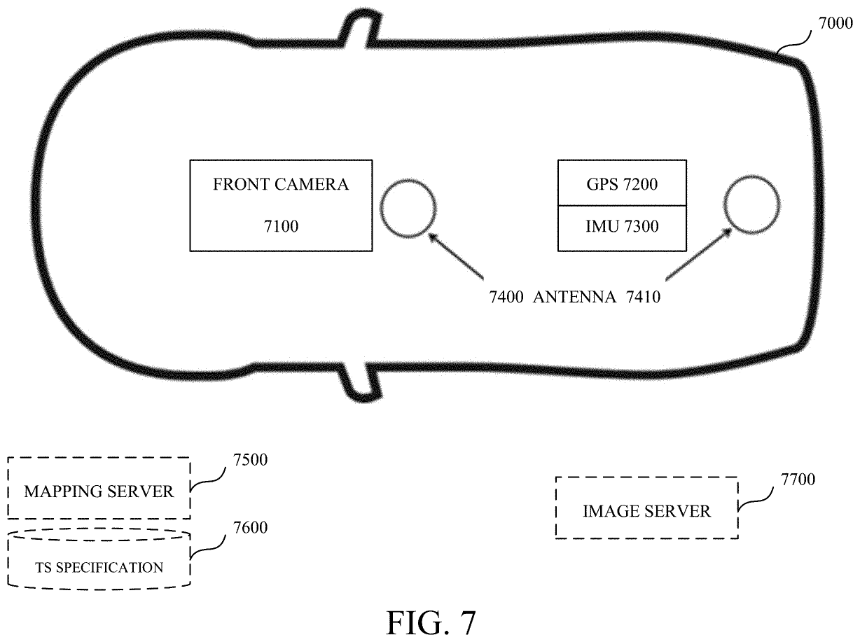

FIG. 7 is a diagram of an example of a vehicle 7000, a mapping server 7500, and a traffic signal specification database 7600 in accordance with embodiments of this disclosure. In implementations, the vehicle 7000 includes the description associated with FIGS. 1-6. Vehicle 7000 includes a front camera 7100, a GPS 7200, an IMU 7300, and a pair of antennas 7400 and 7410. The front camera 7100 can capture images of scenes, environments, or the area of interest (collectively “environment”), where the scenes and environments can include traffic signals. The images are captured in a camera coordinate space or camera frame. Objects such as traffic signals in the images have dimensions in terms of image pixels. In implementations, the front camera 7100 is a monocular camera.

In implementations, the front camera 7100 of the vehicle 7000 may be unable to capture images due to weather conditions, tree coverage, and the like. In these instances, a navigation device such as navigation device 5090 can acquire or obtain alternate imagery along with camera information of the environment from a database such as the database 5125 or the database 7700. The location information of the vehicle 7000 can be used to locate and access alternate imagery of the traffic signals in the environment. In implementations, the alternate imagery can be obtained from public, private, opensource, and other databases. For example, OpenStreetMap® camera data can be used as an open source of alternate imagery. OpenStreetMap® lane information data can be used to locate intersections of interest where particular traffic signals are located. For example, data from Google Street View can be used to obtain alternate imagery,

In implementations, a navigation device such as navigation device 5090 can detect and classify the traffic signals. The navigation device can then determine the traffic signal specification from a database such as the database 5125. The navigation device can then use the traffic signal specification, the traffic signal size in image pixels, the focal length, measurements from the GPS 7200, and the IMU 7300 to determine a 3D position in global coordinates for each of the traffic signals in the image. These 3D positions can then be saved in a HD Map such as digital map 5120. In implementations where the image is alternate imagery, the navigation device can detect the traffic signals in the alternate imagery obtained from the database 5125 or the database 7700. Consequently, the navigation device can, by using a combination of feature-based and pixel-based alignment techniques, determine an estimated location of the traffic signal with respect to the current environment in global coordinates.

In implementations, the mapping server 7500 can obtain the image from the vehicle 7000, the data from the GPS 7200, and the data from the IMU 7300. The mapping server 7500 can then determine the traffic signal specification from a database such as database 7600. The mapping server 7500 can then use the traffic signal specification, the traffic signal size in image pixels, the focal length, measurements from the GPS 7200, and the IMU 7300 to determine a 3D position in global coordinates for each of the traffic signals in the image. These 3D positions can then be transmitted to the vehicle 7000 and other vehicles. The 3D positions can be saved in a HD Map such as digital map 5120. In implementations where the image is alternate imagery, the mapping server 7500 can detect the traffic signals in the alternate imagery obtained from the database 7600 or the database 7700. Consequently, the mapping server 7500 can, by using a combination of feature-based and pixel-based alignment techniques, determine an estimated location of the traffic signal with respect to the current environment in global coordinates.

In implementations, both the navigation device in a vehicle such as vehicle 7000 and the mapping server 7500 can perform the 3D position determinations. This can facilitate updating of the digital maps in an efficient and timely manner.

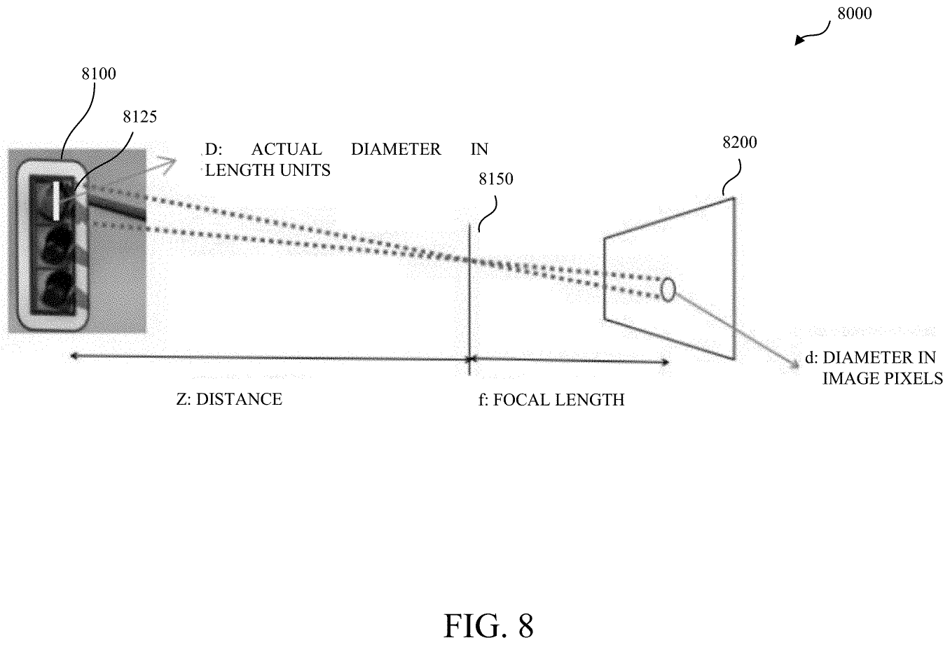

FIG. 8 is a diagram of an example of a general framework 8000 for measuring and mapping traffic signals in global or world coordinates in accordance with embodiments of this disclosure. In implementations, HD/MD Maps such as digital map 5120 store global coordinates for a traffic signal's control points. Control points are reference points for the traffic signal. For example, a center point of a traffic light can be the red, yellow, or green light circles. For example, a center point of a red, yellow, or green light on a traffic light can be control point. For example, the four corners of a traffic sign can be the control points. The description herein is with respect to determining a 3D global coordinate or position for a center point of a traffic light. Control points with respect to any traffic signal can be used without departing from the scope of the specification, claims, or both.

The general framework 8000 shows a projection of a traffic light 8100 to an image plane 8200 using a pinhole camera model can be represented by Equation (1):

$$\frac{Z}{f} = \frac{D}{d} \qquad Equation ( 1 )$$

where Z is the distance between the traffic light 8100 and a focal point 8150, f is the focal length of a camera such as front camera 7100 in FIG. 7, D is the diameter of a defined traffic light signal 8125 of the traffic light 8100 and d is the diameter in the image plane 8200. D is actual length which is measured in length unit such as meters, feet, and the like and d is measured in image pixels.

The forward projection 3D coordinate in the camera frame is transformed to a 2D pixel coordinate using Equation (2):

$$[ \begin{matrix}u \\ v \\ 1\end{matrix} ] = \frac{1}{Z} [ \begin{matrix}{f}_{x} & 0 & {c}_{x} \\ 0 & {f}_{y} & {c}_{y} \\ 0 & 0 & 1\end{matrix} ] {p}_{cam} where {p}_{cam} = [ \begin{matrix}X \\ Y \\ Z\end{matrix} ] \qquad Equation ( 2 )$$

where [u, v] is the pixel position in the image frame 8200, p_{cam} is the defined traffic light signal 8125 center point in camera frame (i.e., the control point) and P_{cam}'s 3D position is represented as [X, Y, Z], fₓ and f_{y} are the focal length of the camera in the x axis and the y axis (extrinsic camera calibration information), and cₓ and c_{y} are intrinsic camera calibration information. The focal length of the camera is represented as shown in Equation (3):

f=\sqrt{fₓ²+f_{y}²} Equation (3)

The distance Z between the defined traffic light signal 8125 and the focal point 8150 can be determined by re-arranging Equation (1) as Equation (4):

$$Z = \frac{D f}{d} \qquad Equation ( 4 )$$

The X and Y position of the defined traffic light signal 8125 can be determined from Equation (2) as Equation (5):

$$X = \frac{( u - {c}_{x} ) Z}{{f}_{x}} and Y = \frac{( v - {c}_{y} ) Z}{{f}_{y}} \qquad Equation ( 5 )$$

The 3D coordinate of the center point of the defined traffic light signal 8125, p_{cam}, can be determined by combining Equations (4) and (5) into Equation (6):

$${p}_{cam} = [ \frac{( u - {c}_{x} ) D f}{{f}_{{x}^{d}}} , \frac{( v - {c}_{y} ) D f}{{f}_{{y}^{d}}} , \frac{D f}{d} ] \qquad Equation ( 6 )$$

In implementations, measurements from GPS/GNSS devices such as GPS/GNSS 5142 and from IMU devices such as IMU 5146 are assumed to be based on an IMU frame. Consequently, a Universal Transverse Mercator (UTM) coordinate frame can be used to ensure that the global coordinate is also a cartesian coordinate which has a small range, i.e., resolution. Other coordinate systems which have the same characteristics can be used without departing from the scope of the specification or the claims.

A point p_{cam} measured in the camera frame can be transformed to a point p_{w} in a global frame using Equation (7):

$$[ \begin{matrix}{p}_{w} \\ 1\end{matrix} ] = {H}_{imu}^{w} {H}_{cam}^{imu} [ \begin{matrix}{p}_{cam} \\ 1\end{matrix} ] \qquad Equation ( 7 )$$

where Hᵢₘᵤ^{w} ∈ R^{4×4}, H_{cam}^{imu} ∈ R^{4×4} are transformation matrices from a IMU frame to a global frame and from camera frame to a IMU frame, respectively.

Using Equation (5), the estimated 3D point in the global frame is shown in Equation (8):

$$[ \begin{matrix}{p}_{w} \\ 1\end{matrix} ] = {H}_{imu}^{w} {H}_{cam}^{imu} [ \begin{matrix}\frac{( u - {c}_{x} ) Df}{{f}_{x} d} \\ \frac{( v - {c}_{y} ) DF}{{f}_{y} d} \\ \frac{Df}{d} \\ 1\end{matrix} ] \qquad Equation ( 7 )$$

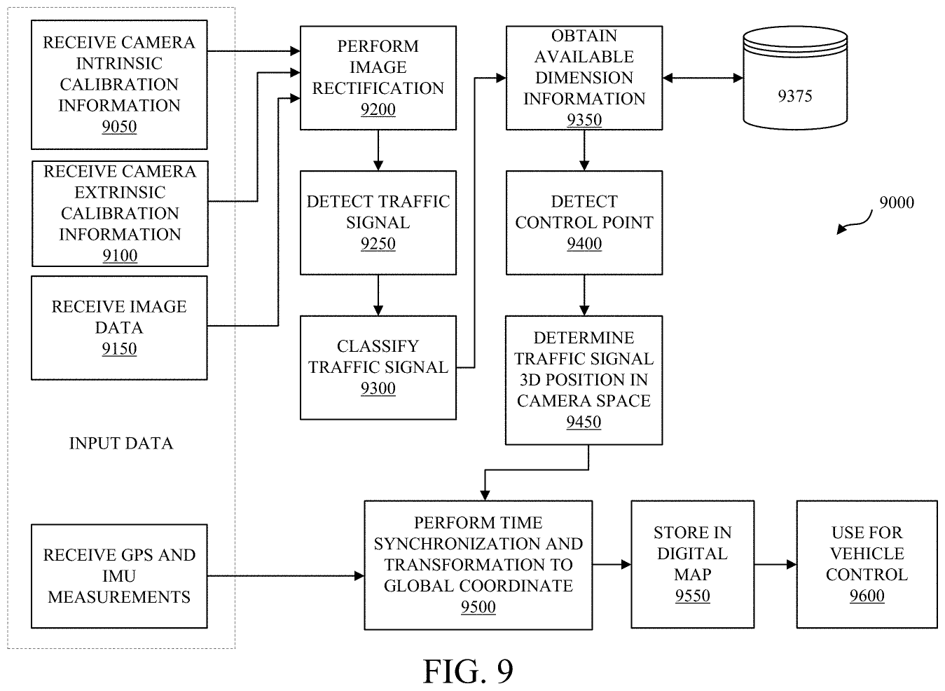

FIG. 9 is a diagram of an example of a technique or method 9000 for measuring and mapping traffic signals in global or world coordinates in accordance with embodiments of this disclosure. The method 9000 includes: receiving 9050 intrinsic calibration information; receiving 9100 extrinsic calibration information; receiving 9150 image of environment; performing 9200 image rectification; detecting 9250 traffic signal from the image; classifying 9300 the detected traffic signal; obtaining 9350 traffic signal specification information from database for the classified traffic signal; detecting 9400 control point(s) for the classified traffic signal; determining 9450 3D position of the control point(s) for the classified traffic signal in camera space; receiving 9500 GPS and IMU measurements; performing 9550 time synchronized transformation of the 3D position of the control point(s) for the classified traffic signal in camera space to global coordinates using the GPS and IMU measurements; storing 9600 the global coordinates for the control point(s) for the classified traffic signal in a digital map database; and use 9650 the digital map database for controlling a vehicle. For example, the technique 9000 may be implemented, as applicable and appropriate, by the navigation device 5090 shown in FIG. 5, the map 5120 shown in FIG. 5, the TS specification 5125 shown in FIG. 5, the database 5125 shown in FIG. 5, the camera 5170 shown in FIG. 5, the GPS/GNSS 5142 shown in FIG. 5, the vehicle controller 5020 shown in FIG. 5, the front camera 7100 shown in FIG. 7, the GPS 7200 shown in FIG. 7, the IMU 7300 shown in FIG. 7, the mapping server 7500 shown in FIG. 7, the TS specification 7600 shown in FIG. 7, the image server 7700 shown in FIG. 7, the vehicle 7000 shown in FIG. 7, the control system 1010 shown in FIG. 1, the processor 1020 shown in FIG. 1 or FIG. 2 or the processing unit 3010 shown in FIG. 3 or FIG. 4.

The method 9000 includes receiving 9050 intrinsic calibration information. The intrinsic calibration information can be obtained by pre-calibration of the camera used for capturing images or found from manufacturer specifications.

The method 9000 includes receiving 9100 extrinsic calibration information. The extrinsic calibration information can include, for example, the distance between the GPS and IMU devices and other like information.

The method 9000 includes receiving 9150 image of environment. In implementations, image information can be obtained from cameras onboard a vehicle, where the vehicle can be an autonomous vehicle or an assisted driving system for the vehicle. In implementations, onboard cameras are unable to capture images due to object occlusion and the like. In this instances, image information can be obtained from other sources which have image databanks. Images and image information can be obtained from these sources based on vehicle location (collectively “alternate imagery”). In implementations, captured images and alternate imagery can be used to reinforce or confirm 3D global coordinate positions of traffic signals.

The method 9000 includes performing 9200 image rectification. The capture images, alternate imagery, or combinations thereof can undergo image rectification. In implementations, image rectification can include undistorting or correcting image distortion using the camera intrinsic information.

The method 9000 includes detecting 9250 traffic signal from the image. Object detection techniques such as, but not limited to, blob detection, machine learning based object segmentation, and the like, can be used to get the contours of a traffic signal. For alternate imagery, a combination of feature-based and pixel-based alignment can be used to get an estimated location of the traffic signal in the current environment. Object detection techniques can be used for traffic signal detection on the alternate imagery.

The method 9000 includes classifying 9300 the detected traffic signal. Object classification techniques based on or using statistical, machine learning, and neural network techniques or implementations can be used for traffic signal classification.

The method 9000 includes obtaining 9350 traffic signal specification information from database for the classified traffic signal. Traffic signal specification information can be obtained from a database 9375 for the classified traffic signal. The traffic signal specification information can include a range of sizes, range of diameters, and other like information regarding the traffic signals.

The method 9000 includes detecting 9400 control point(s) for the classified traffic signal. Blob detection and like techniques can be used to determine a control point(s) for the classified traffic signal. Control point(s) depend on the type of traffic signal. For example, a traffic sign can use the four corners as control points and a traffic light can use a center point of one of the traffic light signals as the control point. Digital maps store the location of the control points.

The method 9000 includes determining 9450 3D position of the control point(s) for the classified traffic signal in camera space. The location of the control point(s) can be determined from the actual size of the traffic signal with respect to the control point(s), the number of image pixels in the image plane, the focal length of the camera, the camera intrinsic calibration information, and the camera extrinsic calibration information. For example, for a traffic light signal, the actual size can be a diameter of one of the traffic light signals. For example, for a traffic sign, the actual size can be the distances between the four corners.

The method 9000 includes receiving 9500 GPS and IMU measurements. The GPS and IMU measurements are needed to obtain 3D global coordinates.

The method 9000 includes performing 9550 time synchronized transformation of the 3D position of the control point(s) for the classified traffic signal in camera space to global coordinates using the GPS and IMU measurements. Transformation matrices from a camera frame to a IMU frame and from a IMU frame to a global frame, both of which incorporate the GPS and IMU measurements, are used to determine the global coordinates of the control point(s).

The method 9000 includes storing 9600 the global coordinates for the control point(s) for the classified traffic signal in a digital map database. The 3D global coordinates for the control point(s) are stored or are transmitted and stored in digital map(s).

The method 9000 includes using 9650 the digital map database for controlling a vehicle. Autonomous vehicles or assisted driving vehicles use the digital maps, which include the control point(s), to control vehicle actions or operate the vehicle.

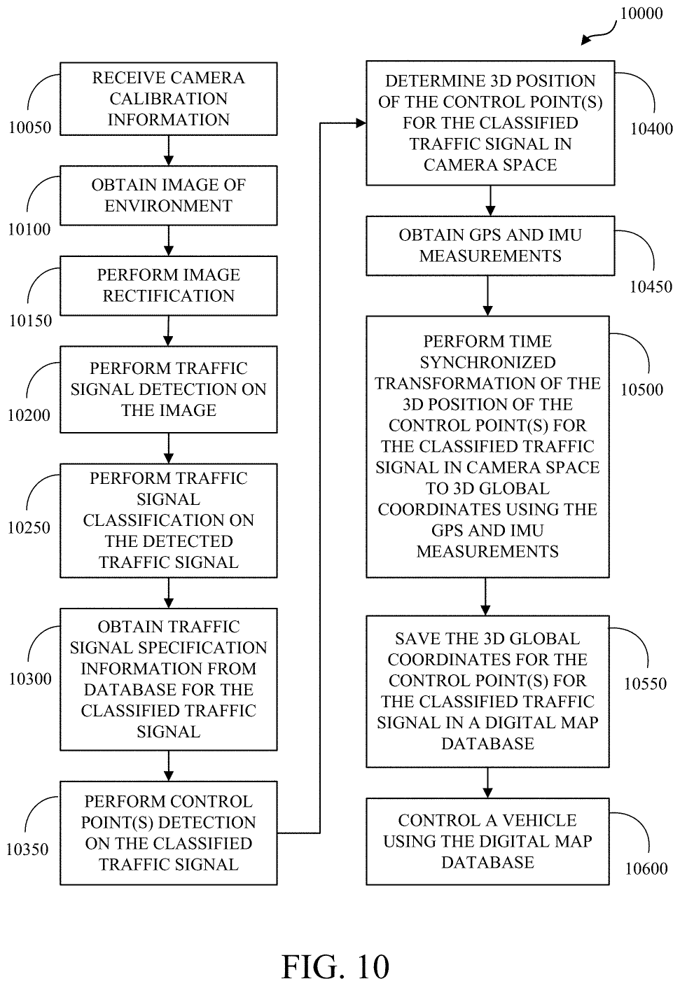

FIG. 10 is a diagram of an example of a technique or method 9000 for measuring and mapping traffic signals in global or world coordinates in accordance with embodiments of this disclosure. The method 10000 includes: obtaining 10050 camera calibration information; obtaining 10100 image of environment; performing 10150 image rectification; performing 10200 traffic signal detection on the image; performing 10250 traffic signal classification on the detected traffic signal; obtaining 10300 traffic signal specification information from database for the classified traffic signal; performing 10350 control point(s) detection on the classified traffic signal; determining 10400 3D position of the control point(s) for the classified traffic signal in camera space; obtaining 10450 GPS and IMU measurements; performing 10500 time synchronized transformation of the 3D position of the control point(s) for the classified traffic signal in camera space to 3D global coordinates using the GPS and IMU measurements; saving 10550 the 3D global coordinates for the control point(s) for the classified traffic signal in a digital map database; and controlling 10600 a vehicle using the digital map database. For example, the technique 10000 may be implemented, as applicable and appropriate, by the navigation device 5090 shown in FIG. 5, the map 5120 shown in FIG. 5, the TS specification 5125 shown in FIG. 5, the database 5125 shown in FIG. 5, the camera 5170 shown in FIG. 5, the GPS/GNSS 5142 shown in FIG. 5, the vehicle controller 5020 shown in FIG. 5, the front camera 7100 shown in FIG. 7, the GPS 7200 shown in FIG. 7, the IMU 7300 shown in FIG. 7, the mapping server 7500 shown in FIG. 7, the TS specification 7600 shown in FIG. 7, the image server 7700 shown in FIG. 7, the vehicle 7000 shown in FIG. 7, the control system 1010 shown in FIG. 1, the processor 1020 shown in FIG. 1 or FIG. 2 or the processing unit 3010 shown in FIG. 3 or FIG. 4.

The method 10000 includes obtaining 10050 camera calibration information. The calibration information can include intrinsic calibration information and extrinsic calibration information. The intrinsic calibration information can be obtained by pre-calibration of the camera used for capturing images or found from manufacturer specifications. The extrinsic calibration information can include, for example, the distance between the GPS and IMU devices and other like information.

The method 10000 includes obtaining 10100 an image of environment. In implementations, image information can be obtained from cameras onboard a vehicle, where the vehicle can be an autonomous vehicle or an assisted driving system for the vehicle. In implementations, onboard cameras are unable to capture images due to object occlusion and the like. In this instances, image information can be obtained from other sources which have image databanks. Images and image information can be obtained from these sources based on vehicle location (collectively “alternate imagery”). In implementations, captured images and alternate imagery can be used to reinforce or confirm 3D global coordinate positions of traffic signals.

The method 10000 includes performing 10150 image rectification. The capture images, alternate imagery, or combinations thereof can undergo image rectification.

The method 10000 includes performing 10200 traffic signal detection on the image. Object detection techniques such as, but not limited to, blob detection, machine learning based object segmentation, and the like, can be used to get the contours of a traffic signal. For alternate imagery, a combination of feature-based and pixel-based alignment can be used to get an estimated location of the traffic signal in the current environment. Object detection techniques can be used for traffic signal detection on the alternate imagery.

The method 10000 includes performing 10250 traffic signal classification on the detected traffic signal. Object classification techniques based on or using statistical, machine learning, and neural network techniques or implementations can be used for traffic signal classification.

The method 10000 includes obtaining 10300 traffic signal specification information from database for the classified traffic signal. Traffic signal specification information can be obtained from a database 9375 for the classified traffic signal. The traffic signal specification information can include a range of sizes, range of diameters, and other like information regarding the traffic signals.

The method 10000 includes performing 10350 control point(s) detection on the classified traffic signal. Blob detection and like techniques can be used to determine a control point(s) for the classified traffic signal. Control point(s) depend on the type of traffic signal. For example, a traffic sign can use the four corners as control points and a traffic light can use a center point of one of the traffic light signals as the control point. Digital maps store the location of the control points.

The method 10000 includes determining 10400 3D position of the control point(s) for the classified traffic signal in camera space. The location of the control point(s) can be determined from the actual size of the traffic signal with respect to the control point(s), the number of image pixels in the image plane, the focal length of the camera, the camera intrinsic calibration information, and the camera extrinsic calibration information. For example, for a traffic light signal, the actual size can be a diameter of one of the traffic light signals. For example, for a traffic sign, the actual size can be the distances between the four corners.

The method 10000 includes obtaining 10450 GPS and IMU measurements. The GPS and IMU measurements are needed to obtain 3D global coordinates.

The method 10000 includes performing 10500 time synchronized transformation of the 3D position of the control point(s) for the classified traffic signal in camera space to 3D global coordinates using the GPS and IMU measurements. Transformation matrices from a camera frame to a IMU frame and from a IMU frame to a global frame, both of which incorporate the GPS and IMU measurements, are used to determine the global coordinates of the control point(s).

The method 10000 includes saving 10550 the 3D global coordinates for the control point(s) for the classified traffic signal in a digital map database. The 3D global coordinates for the control point(s) are stored or are transmitted and stored in digital map(s).

The method 10000 includes controlling 10600 a vehicle using the digital map database. Autonomous vehicles or assisted driving vehicles use the digital maps, which include the control point(s), to control vehicle actions or operate the vehicle.

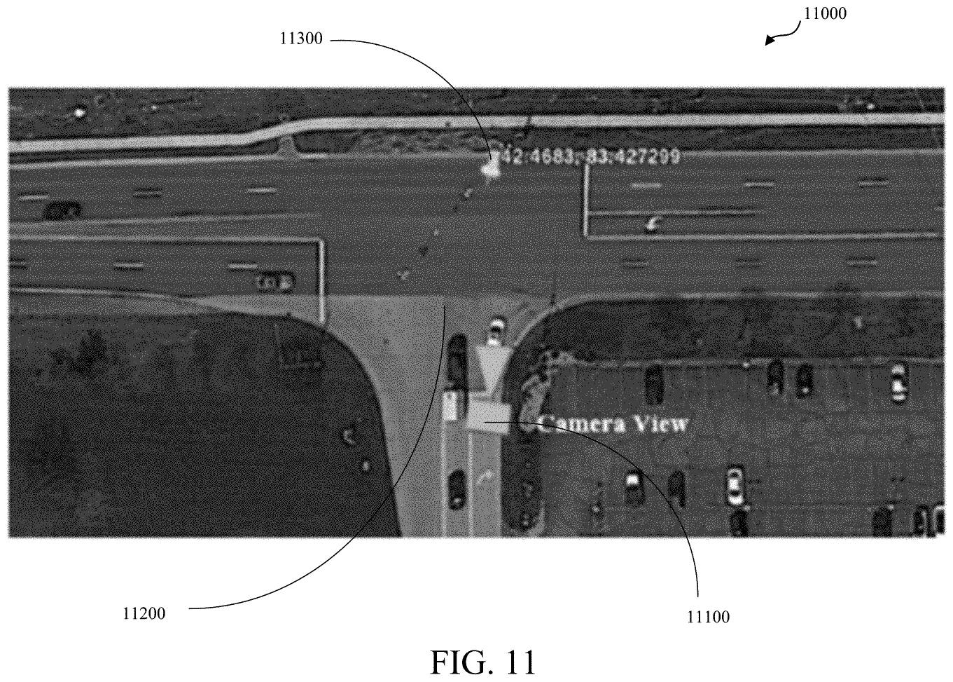

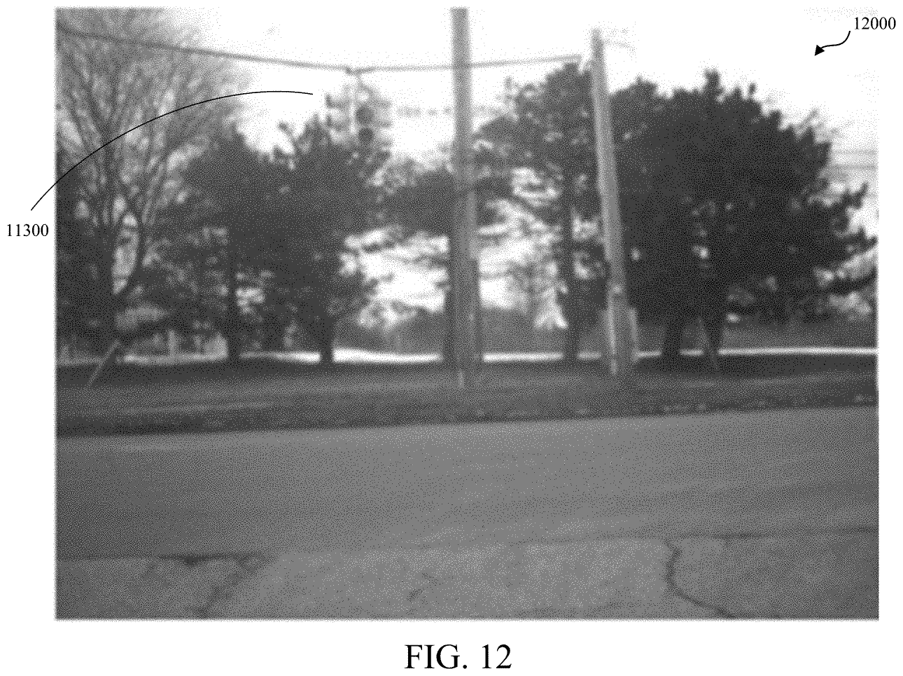

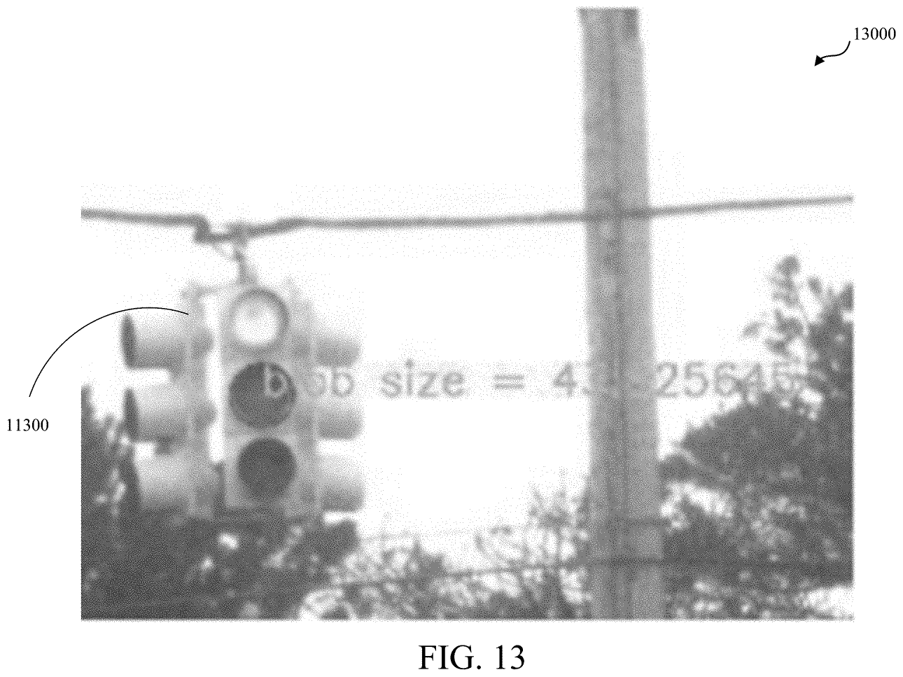

Experiments were conducted to evaluate the performance of the described technique. FIG. 11 shows a top view photograph of a vehicle 11100 approaching an intersection 11200 which includes a traffic light 11300. FIG. 12 shows an image of the traffic light 11300 of FIG. 11. FIG. 13 shows a close-up image of the traffic light 11300 of FIG. 11 with a blob detection and size. The Universal Transverse Mercator (UTM) global coordinates of the traffic light 11300 was East: 300452.128595 North: 4704628.018028 Altitude: 225.753846. This matches the publicly available information regarding this traffic light.

In general, a method for measuring a traffic signal in global coordinates, the method including obtaining an image of an environment for a vehicle location, detecting a traffic signal in the image, classifying the detected traffic signal, obtaining traffic signal specification information associated with the classified traffic signal, determining a control point associated with the classified traffic signal, determining a 3D position of the control point in camera space using the traffic signal specification information, camera calibration information, image pixel size, and focal length of camera used in capturing the image, transforming the 3D position of the control point in the camera space to a 3D position of the control point in global coordinates, saving the 3D position of the control point in global coordinates in a digital map, and controlling operation of a vehicle with 3D positions of control points in global coordinates saved in the digital map. In implementations, the traffic signal specification information includes at least an actual size of the traffic signal. In implementations, the obtaining further including at least one of capturing the image using a camera onboard the vehicle, and obtaining the image and associated information from an image databank using the vehicle location. In implementations, the image is multiple images and the obtaining further including at least both of capturing an image using a camera onboard the vehicle, and obtaining another image and associated information from an image databank using the vehicle location. In implementations, the transforming further including using global positioning system and inertial measurement unit data to time synchronize and transform the 3D position of the control point in the camera space to the 3D position of the control point in global coordinates. In implementations, further including performing image rectification on the image. In implementations, further including obtaining the camera calibration information, wherein the camera calibration information includes intrinsic camera calibration information and extrinsic camera calibration information.

In general, a system including a digital map configured to store 3D positions of control points of traffic signals in global coordinates, a processor in communication with the digital map, the processor configured to obtain an image of environment for a vehicle location, detect a traffic signal in the image, classify the detected traffic signal, obtain traffic signal specification information associated with the classified traffic signal, determine a control point associated with the classified traffic signal, determine a 3D position of the control point in camera space using the traffic signal specification information, camera calibration information, image pixel size, and focal length of camera used in capturing the image, transform the 3D position of the control point in the camera space to a 3D position of the control point in global coordinates, save the 3D position of the control point in global coordinates in the digital map, and a controller connected to the digital library, the controller configured to control operation of a vehicle with 3D positions of control points of traffic signals in global coordinates saved in the digital library. In implementations, the traffic signal specification information includes at least an actual size of the traffic signal. In implementations, further including a camera connected to the processor, the camera configured to capture the image. In implementations, the processor configured to obtain the image and associated information from an image databank using the vehicle location. In implementations, the processor configured to obtain global positioning system and inertial measurement unit data to time synchronize and transform the 3D position of the control point in the camera space to the 3D position of the control point in global coordinates. In implementations, the processor configured to perform image rectification on the image. In implementations, the processor configured to obtain the camera calibration information, wherein the camera calibration information includes intrinsic camera calibration information and extrinsic camera calibration information. In implementations, the processor is in the vehicle. In implementations, the processor is a computing device external to the vehicle. In implementations, wherein multiple images are obtained and the system further including a camera connected to the processor, the camera configured to capture an image, and the processor further configured to obtain another image and associated information from an image databank using the vehicle location.

In general, a method for measuring a traffic signal in global coordinates, the method including receiving an image of a scene corresponding to a location of a vehicle, performing object detection to detect a traffic signal in the image, performing classification of the traffic signal detected in the image, obtaining traffic signal specifications associated with the classified traffic signal, performing object detection on the classified traffic signal to obtain a control point; determining a 3D position in camera space of the control point using the traffic signal specifications, image pixel size, and focal length of camera used in capturing the image, transforming the 3D position of the control point in camera space to a 3D position of the control point in global coordinates, storing the 3D position of the control point in global coordinates in a digital map, and operating the vehicle with 3D positions of control points in global coordinates saved in the digital map. In implementations, the traffic signal specification information includes at least an actual size of the traffic signal. In implementations, the receiving further including obtaining the image and associated information from an image databank using the location of the vehicle.

Although some embodiments herein refer to methods, it will be appreciated by one skilled in the art that they may also be embodied as a system or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “processor,” “device,” or “system.” Furthermore, aspects of the present invention may take the form of a computer program product embodied in one or more the computer readable mediums having the computer readable program code embodied thereon. Any combination of one or more computer readable mediums may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to CDs, DVDs, wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowcharts and block diagrams in the figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures.

While the disclosure has been described in connection with certain embodiments, it is to be understood that the disclosure is not to be limited to the disclosed embodiments but, on the contrary, is intended to cover various modifications, combinations, and equivalent arrangements included within the scope of the appended claims, which scope is to be accorded the broadest interpretation so as to encompass all such modifications and equivalent structures as is permitted under the law.

What is claimed is:

1. A method for measuring a traffic signal in global coordinates, the method comprising:
obtaining an image of an environment for a vehicle location;
detecting a traffic signal in the image;
classifying the detected traffic signal;
obtaining traffic signal specification information associated with the classified traffic signal;
determining a control point associated with the classified traffic signal;
determining a 3D position of the control point in camera space using the traffic signal specification information, camera calibration information, image pixel size, and focal length of camera used in capturing the image;
transforming the 3D position of the control point in the camera space to a 3D position of the control point in global coordinates;
saving the 3D position of the control point in global coordinates in a digital map; and
controlling operation of a vehicle with 3D positions of control points in global coordinates saved in the digital map.

2. The method of claim 1, wherein the traffic signal specification information includes at least an actual size of the traffic signal.

3. The method of claim 2, wherein the obtaining further comprising at least one of:
capturing the image using a camera onboard the vehicle; and
obtaining the image and associated information from an image databank using the vehicle location.

4. The method of claim 3, wherein the image is multiple images and the obtaining further comprising at least both of:
capturing an image using a camera onboard the vehicle; and
obtaining another image and associated information from an image databank using the vehicle location.

5. The method of claim 4, wherein the transforming further comprising:
using global positioning system and inertial measurement unit data to time synchronize and transform the 3D position of the control point in the camera space to the 3D position of the control point in global coordinates.

6. The method of claim 5, further comprising:
performing image rectification on the image.

7. The method of claim 6, further comprising:
obtaining the camera calibration information, wherein the camera calibration information includes intrinsic camera calibration information and extrinsic camera calibration information.

8. A system comprising:
a digital map configured to store 3D positions of control points of traffic signals in global coordinates;
a processor in communication with the digital map, the processor configured to:
obtain an image of environment for a vehicle location;
detect a traffic signal in the image;
classify the detected traffic signal;
obtain traffic signal specification information associated with the classified traffic signal;
determine a control point associated with the classified traffic signal;
determine a 3D position of the control point in camera space using the traffic signal specification information, camera calibration information, image pixel size, and focal length of camera used in capturing the image;
transform the 3D position of the control point in the camera space to a 3D position of the control point in global coordinates;
save the 3D position of the control point in global coordinates in the digital map; and
a controller connected to the digital library, the controller configured to control operation of a vehicle with 3D positions of control points of traffic signals in global coordinates saved in the digital library.

9. The system of claim 8, wherein the traffic signal specification information includes at least an actual size of the traffic signal.

10. The system of claim 9, further comprising:
a camera connected to the processor, the camera configured to capture the image.

11. The system of claim 9, the processor configured to obtain the image and associated information from an image databank using the vehicle location.

12. The system of claim 11, the processor configured to obtain global positioning system and inertial measurement unit data to time synchronize and transform the 3D position of the control point in the camera space to the 3D position of the control point in global coordinates.

13. The system of claim 12, wherein the processor configured to perform image rectification on the image.

14. The system of claim 13, wherein the processor configured to obtain the camera calibration information, wherein the camera calibration information includes intrinsic camera calibration information and extrinsic camera calibration information.

15. The system of claim 14, wherein the processor is in the vehicle.

16. The system of claim 14, wherein the processor is a computing device external to the vehicle.

17. The system of claim 9, wherein multiple images are obtained and the system further comprising:
a camera connected to the processor, the camera configured to capture an image; and
the processor further configured to obtain another image and associated information from an image databank using the vehicle location.

18. A method for measuring a traffic signal in global coordinates, the method comprising:
receiving an image of a scene corresponding to a location of a vehicle;
performing object detection to detect a traffic signal in the image;
performing classification of the traffic signal detected in the image;
obtaining traffic signal specifications associated with the classified traffic signal;
performing object detection on the classified traffic signal to obtain a control point;
determining a 3D position in camera space of the control point using the traffic signal specifications, image pixel size, and focal length of camera used in capturing the image;
transforming the 3D position of the control point in camera space to a 3D position of the control point in global coordinates;
storing the 3D position of the control point in global coordinates in a digital map; and
operating the vehicle with 3D positions of control points in global coordinates saved in the digital map.

19. The method of claim 18, wherein the traffic signal specification information includes at least an actual size of the traffic signal.

20. The method of claim 19, wherein the receiving further comprising obtaining the image and associated information from an image databank using the location of the vehicle.
